(19) United States
(12) Patent Application Publication
(10) Pub. No.: US 2025/0347629 A1
(43) Pub. Date: Nov. 13, 2025

(54) INSPECTION DEVICE, INSPECTION METHOD, AND METHOD OF MANUFACTURING PISTON

(71) Applicant: Hitachi Astemo, Ltd., Hitachinaka-shi, Ibaraki (JP)

(72) Inventors: Takehisa ICHIHARA, Hitachinaka-shi, Ibaraki (JP); Hideaki ONOZUKA, Hitachinaka-shi, Ibaraki (JP); Takamasa IMAIZUMI, Hitachinaka-shi, Ibaraki (JP); Hiroyuki HAYASHI, Hitachinaka-shi, Ibaraki (JP)

(21) Appl. No.: 18/019,170

(22) PCT Filed: Jul. 28, 2021
(86) PCT No.: PCT/JP2021/027882

§ 371 Date: Dec. 16, 2024

(30) Foreign Application Priority Data
Aug. 3, 2020 (JP) 2020-131675

(51) Int. Cl. G01N 21/88; G06T 7/00; H04N 23/56

(52) U.S. Cl. CPC G01N 21/8806; G06T 7/001; H04N 23/56; G01N 2021/8825; G06T 2207/10152

(57) ABSTRACT

A plurality of surface images are picked up while changing a relative posture of a surface of an object to be inspected with respect to an image pickup part configured to pick up an image of the surface of the object to be inspected under a state in which the surface of the object to be inspected is irradiated with light, and a defect and luminance unevenness of the surface of the object to be inspected are discriminated from each other based on a change in the plurality of surface images.

### TECHNICAL FIELD

The present invention relates to an inspection device, an inspection method, and a method of manufacturing a piston.

### BACKGROUND ART

In Patent Literature 1, there is described an inspection device that inspects an outer peripheral surface of an object to be inspected including a cylindrical or columnar main body part. This inspection device rotates the object to be inspected so as to photograph a bright-field region, a dark-field region, and a boundary region between the bright-field region and the dark-field region. The inspection device detects a defective area of the outer peripheral surface of the objected to be inspected based on the photographed images.

### CITATION LIST

### Patent Literature

PTL 1: JP 2016-65782 A

### SUMMARY OF INVENTION

### Technical Problem

With the above-mentioned related-art technology, however, when each of the photographed images has a low luminance area or a high luminance area, such an area is detected as a defective area. Thus, for example, when an image obtained by photographing the bright-field region has a low luminance area, the low luminance area is detected as a defect even though the low luminance area represents mere surface luminance unevenness. As a result, a reinspection is required, and thus productivity in a visual inspection of the object to be inspected may decrease.

### Solution to Problem

An object of the present invention is to provide an inspection device, an inspection method, and a method of manufacturing a piston, which improve discrimination accuracy between a defect and luminance unevenness of a surface so as to achieve improvement of productivity in an inspection of an object to be inspected.

The inspection device according to one embodiment of the present invention picks up a plurality of surface images while changing a relative posture of a surface of the object to be inspected with respect to an image pickup part that picks up an image of the surface of the object to be inspected under a state in which the surface of the object to be inspected is irradiated with light, and discriminates between the defect and the luminance unevenness of the surface of the object to be inspected based on a change in the plurality of surface images.

According to one embodiment of the present invention, discrimination accuracy between the defect and the luminance unevenness of the surface is improved so as to achieve improvement of productivity in the inspection of the object to be inspected.

### BRIEF DESCRIPTION OF DRAWINGS

FIG. 1 is a diagram for illustrating manufacturing processes for a piston for an internal combustion engine.

FIG. 2 is a schematic view of an inspection device 1 to be used in a visual inspection process.

FIG. 3 is an explanatory view of an inspection method performed with use of the inspection device 1.

FIG. 4 is a flowchart for illustrating flow of the inspection method performed by a controller 6.

FIG. 5 is a table for showing a surface image picked up in a bright field and its center luminance distribution characteristic for each of viewing angles when a crown surface 7a has a dent.

FIG. 6 is a table for showing a surface image picked up in the bright field and its center luminance distribution characteristic for each of viewing angles when the crown surface 7a has luminance unevenness.

### DESCRIPTION OF EMBODIMENTS

### First Embodiment

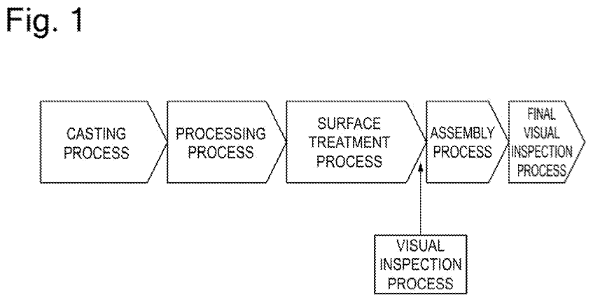

FIG. 1 is a diagram for illustrating manufacturing processes for a piston for an internal combustion engine.

The manufacturing processes for a piston include a casting process, a processing process, a surface treatment process, an assembly process, and a final visual inspection process. In the casting process, a piston material is subjected to casting. After casting, a thermal treatment is performed. In the processing process, the piston material is mechanically processed with use of, for example, a lathe after the thermal treatment. In the surface treatment process, a surface of the piston is coated. In the assembly process, a piston ring is mounted in a ring groove of a finished piston product. In the final visual inspection process, final defect detection is performed on the piston with use of an image sensor. Further, a visual inspection process (second process) is performed between the surface treatment process (first process) and the assembly process (third process). In the visual inspection process, a defective (such as a flaw or a dent) area of a crown surface (surface) of the finished piston product is detected.

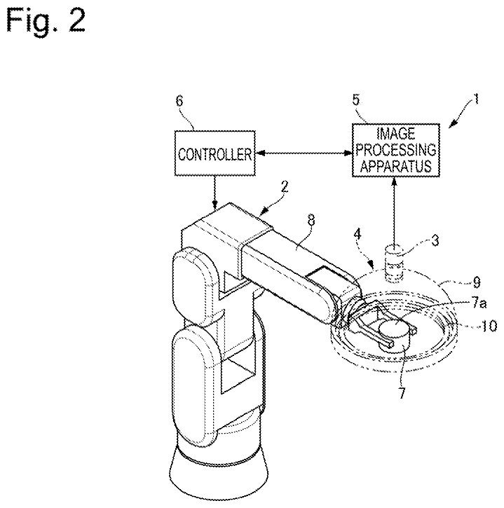

FIG. 2 is a schematic view of an inspection device 1 to be used in the visual inspection process.

The inspection device 1 includes a robot 2, a camera (image pickup part) 3, an illumination device (illumination part) 4, an image processing apparatus 5, and a controller (posture control part) 6. The robot 2 is an articulated robot. The robot 2 has a hand (holding part) 8 for holding a piston material or a finished piston product (hereinafter referred to simply as “main body part”) 7, each being an object to be inspected. The camera 3 is supported with its lens directed downward in a vertical direction. The illumination device 4 irradiates a crown surface 7a of the main body part 7 with light. The illumination device 4 includes a dome 9 and a ring light 10. The dome 9 accommodates the main body part 7 and the ring light 10. The dome 9 reflects and diffuses light emitted from the ring light 10. The dome 9 is located below the camera 3 in the vertical direction and is fixed integrally with the camera. The camera 3 picks up an image of the crown surface 7a of the main body part 7 through an opening formed at an upper end of the dome 9. The ring light 10 is an annular LED light arranged so as to surround the main body part 7. The ring light 10 is supported by a support device (not shown) so as to be rotatable about a center axis of the camera 3 with respect to the camera 3 and the dome 9.

The image processing apparatus 5 performs image processing. The image processing involves extraction of a candidate defective portion from a surface image of the main body part 7, which is picked up by the camera 3, and generation of, for example, an 8-bit (256-gradation) grayscale image from the candidate defective portion. The controller 6 outputs to the robot 2 a command for changing a relative viewing angle (posture angle) of the crown surface 7a of the main body part 7 with respect to the camera 3. Further, the controller 6 outputs to the camera 3 a command for photographing the crown surface 7a.

Further, the controller 6 outputs to the support device for the ring light 10 a command for changing a rotational position. The controller 6 determines whether or not the crown surface 7a has a defect (flow or dent) based on a change in luminance distribution of a plurality of grayscale images that are picked up for different viewing angles. More specifically, when a luminance difference equal to or larger than a given value is observed in the images picked up for all the viewing angles, it is determined as “defective”. When a luminance difference equal to or larger than the given value is not observed in the images picked up for at least two different viewing angles, it is determined as “non-defective”. Luminance distribution images are acquired in both of a bright field and a dark field. The image processing apparatus 5 can switch a candidate defective portion to one of the bright field and the dark field by changing the rotational position of the ring light 10.

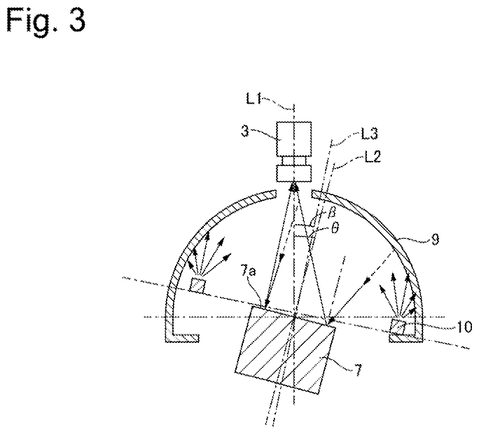

FIG. 3 is an explanatory view of an inspection method performed with use of the inspection device 1.

A center axis (˜optical axis) of the camera 3 is referred as a first center axis L1. A center axis of the main body part 7 is referred to as a second center axis L2. A center axis of the ring light 10 is referred to as a third center axis L3. A center axis of the dome 9 matches the first center axis L1. The second center axis L2 is inclined at a first inclination angle θ with respect to the first center axis L1. The first inclination angle θ corresponds to the viewing angle of the crown surface 7a with respect to the camera 3. Further, the third center axis L3 is inclined at a second inclination angle β (0) with respect to the first center axis L1.

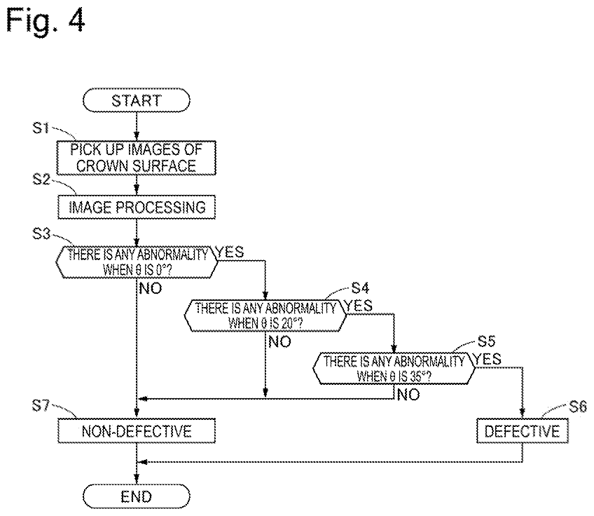

FIG. 4 is a flowchart for illustrating flow of the inspection method performed by the controller 6.

In Step S1, images of the crown surface 7a are picked up in the bright field and the dark field while the viewing angle (first inclination angle) 0 is being changed (image pickup step). The viewing angle θ is set to, for example, three viewing angles of 0°, 20°, and 35°.

In Step S2, a luminance distribution correction is performed for each of the images that have been picked up.

In Step S3, determination is made on whether or not the crown surface 7a has an abnormality based on a change in luminance distribution of grayscale images that are picked up in the bright field and the dark field when the viewing angle θ is set to 0°. When a result of the determination is YES, the processing proceeds to Step S4. When a result of the determination is NO, the processing proceeds to Step S6. In this step, when a luminance difference in at least one of luminance distribution characteristics of the grayscale images that are picked up in the bright field and the dark field exceeds a threshold value, it is determined that the crown surface 7a has an abnormality. When the luminance difference is equal to or smaller than the threshold value, it is determined that the crown surface 7a has no abnormality. When the crown surface 7a has a defective portion, the luminance distribution characteristic has a luminance difference equal to or larger than a given value. In the bright field, a luminance of a defective portion is lower than a luminance of a remaining normal portion. Meanwhile, in the dark field, a luminance of a defective portion is higher than a luminance of a remaining normal portion. Thus, whether or not the crown surface 7a has a defect can be determined based on a luminance difference in the luminance distribution characteristic.

In Step S4, determination is made on whether or not the crown surface 7a has an abnormality based on the luminance distribution characteristics of the grayscale images that are picked up in the bright field and the dark field when the viewing angle θ is set to 20°. When a result of the determination is YES, the processing proceeds to Step S5. When a result of the determination is NO, the processing proceeds to Step S6. A method of determining whether or not the crown surface has an abnormality is the same as that used in Step S3.

In Step S5, determination is made on whether or not the crown surface 7a has an abnormality based on the luminance distribution characteristics of the grayscale images that are picked up in the bright field and the dark field when the viewing angle θ is set to 35°. When a result of the determination is YES, the processing proceeds to Step S7. When a result of the determination is NO, the processing proceeds to Step S6. A method of determining whether or not the crown surface has an abnormality is the same as that used in Step S3.

In Step S6, it is determined that the crown surface 7a has a defect (discrimination step).

In Step S7, it is determined that the crown surface 7a has no defect (discrimination step).

Next, actions and effects of the first embodiment are described.

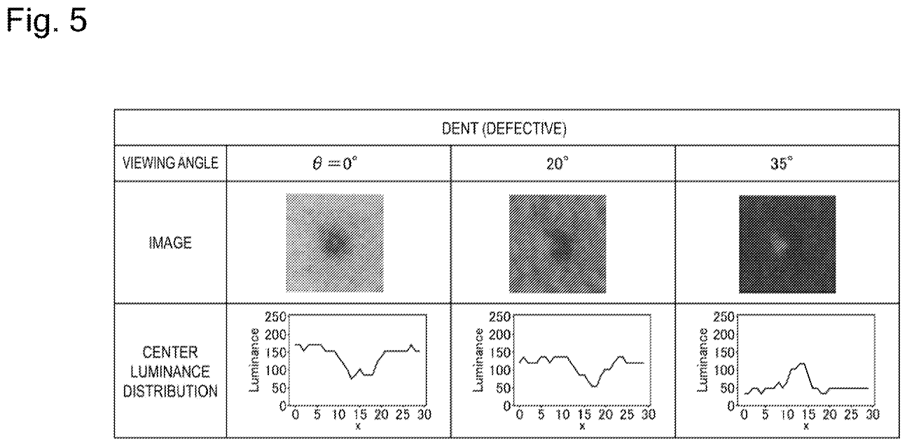

FIG. 5 is a table for showing a surface image that is picked up in the bright field and its center luminance distribution characteristic for each of viewing angles when the crown surface 7a has a dent. In this case, the inspection proceeds in the order of S1, S2, S3, S4, S5, and S6 in the flowchart of FIG. 4. The luminance distribution characteristic has a luminance difference exceeding the threshold value for all the viewing angles. Thus, in Step S6, it is determined that the crown surface 7a has a defect.

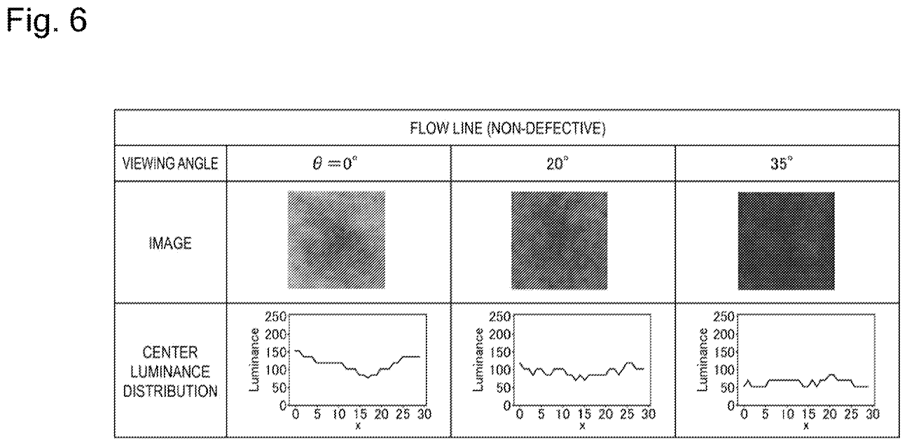

Meanwhile, FIG. 6 is a table for showing a surface image that is picked up in the bright field and its center luminance distribution characteristic for each of viewing angles when the crown surface 7a has luminance unevenness (flow line). In this case, the inspection proceeds in the order of S1, S2, S3, S4, and S7 in the flowchart of FIG. 4. It is determined that the crown surface has an abnormality when the viewing angle θ is 0°. However, the luminance distribution characteristic has a luminance difference equal to or smaller than the threshold value when the viewing angle θ is 20°. Thus, in Step S7, it is determined that the crown surface 7a has no defect.

As described above, the inspection method according to the first embodiment allows discrimination between a defect and luminance unevenness of the crown surface 7a based on a change in luminance distribution of a plurality of surface images that are picked up while the viewing angle of the crown surface 7a of the main body part 7 is being changed with respect to the camera 3. When the crown surface 7a has a defect such as a dent, a luminance difference equal to or larger than a predetermined value always appears in the luminance distribution characteristic of the surface image regardless of the viewing angle θ. Meanwhile, when the crown surface 7a has no defect and has luminance unevenness such as a flow line, a luminance difference equal to or larger than the predetermined value appears in the luminance distribution characteristic of the surface image when the viewing angle is a certain viewing angle. However, a luminance difference in luminance distribution characteristic becomes smaller than the predetermined value when the viewing angle is different from the certain viewing angle. Specifically, discrimination accuracy between a defect and luminance unevenness of the crown surface 7a is improved based on a change in luminance distribution of the surface images that are picked up for different viewing angles, to thereby achieve improvement of productivity in the inspection of the main body part 7.

In the first embodiment, the surface images are picked up in the bright field and the dark field, and a defect and luminance unevenness of the crown surface 7a are discriminated from each other based on a change in luminance distribution of the surface images. In the bright field, a shape and a range of a defective area can be clearly reproduced. However, among the defective areas, it is difficult to clearly reproduce a defective area having a small size, such as a tiny flaw. Meanwhile, in the dark field, among the defective areas, a defective area having a small size, such as a tiny flaw, can be clearly reproduced. However, it is difficult to clearly reproduce a defective area having a large size. Thus, all defective areas having various sizes, shapes, and ranges can be detected without fail based on a change in luminance distribution of the surface images that are picked up in the bright field and the dark field. As a result, discrimination accuracy between a defect and luminance unevenness of the crown surface 7a can be improved.

When the center axis of the camera 3 and the dome 9 is referred to as the first center axis L1, the center axis of the main body part 7 is referred to as the second center axis L2, and the center axis of the ring light 10 is referred to as the third center axis L3, the hand 8 holds the main body part 7 under a state in which the second center axis L2 is inclined at the predetermined first inclination angle (=viewing angle θ) with respect to the first center axis L1. The ring light 10 is arranged so that the third inclination angle L3 is inclined at the second inclination angle β that is different from the first inclination angle. The surface images in the bright field and the dark field are acquired through rotation of the ring light 10 about the first center axis L1. The third center axis L3 of the ring light 10 is inclined with respect to the second center axis L2 of the main body part 7. Thus, when the ring light 10 is rotated about the first center axis L1, the surface images in the bright field and the dark field can be acquired. In this case, the camera 3 and the main body part 7 are in a stationary state relative to each other. Thus, blur in the surface images, which may occur due to the acquisition of the surface images under a state in which the camera 3 and the main body part 7 oscillate relative to each other along with mechanical oscillation, can be prevented.

The controller 6 changes the hand 8 with respect to the camera 3 being fixed, to thereby change the viewing angle θ of the crown surface 7a of the main body part 7 with respect to the camera 3. In general, the robot 2 operates precisely. Thus, the viewing angle θ can easily and precisely be changed.

A method of manufacturing a piston according to the first embodiment includes the surface treatment process, the visual inspection process, and the assembly process. In the surface treatment process, a piston is prepared. In the visual inspection process, the crown surface 7a of the piston that has been prepared in the surface treatment process is inspected. The visual inspection process includes an image pickup step and a discrimination step. In the image pickup step, a plurality of surface images are picked up while a relative posture of the crown surface 7a with respect to the camera 3 that picks up the images of the crown surface 7a is being changed. In the discrimination step, a defect and luminance unevenness of the crown surface 7a are discriminated from each other based on a change in the plurality of surface images. In the assembly process, the piston inspected in the visual inspection process is processed as a post-process. As a result, the discrimination accuracy between a defect and luminance unevenness of the crown surface 7a is improved, to thereby achieve the improvement of the productivity in the inspection of the piston.

### Another Embodiment

The embodiment for carrying out the present invention has been described above. However, a specific configuration of the present invention is not limited to the configuration of the embodiment. For example, design changes that are made without departing from a gist of the invention are also encompassed in the present invention.

In the embodiment, there has been described an example in which the visual inspection process is carried out after the surface treatment process. However, the visual inspection process may be carried out after the casting process or the processing process. In a case in which the visual inspection process is carried out after the casting process, the casting process corresponds to the first process and the processing process corresponds to the third process. In a case in which the visual inspection process is carried out after the processing process, the processing process corresponds to the first process and the surface treatment process corresponds to the third process.

The inspection device and the inspection method according to the present invention can be used as an inspection device and an inspection method that allow discrimination between a defect and luminance unevenness of a surface of the piston other than the crown surface as the surface of the object to be inspected, and the same actions and effects as those of the embodiments are obtained.

Technical ideas that can be understood from the above-mentioned embodiments are described below.

In one aspect, the inspection device is an inspection device for inspecting a surface of an object to be inspected, the inspection device including: a holding part configured to hold the object to be inspected; an illumination part configured to irradiate a surface of the object to be inspected with light; an image pickup part configured to pick up an image of the object to be inspected; a posture control part configured to change a relative posture of the surface of the object to be inspected with respect to the image pickup part; and a discrimination part configured to discriminate between a defect and luminance unevenness of the surface of the object to be inspected based on a change in a plurality of surface images that are picked up while the relative posture is being changed.

In a more preferred aspect, in the above-mentioned aspect, the change in the plurality of surface images is a change in luminance distribution, which corresponds to posture angles representing a plurality of the relative postures, and the discrimination part discriminates between the defect and the luminance unevenness of the surface of the object to be inspected based on the change in luminance distribution.

In another preferred aspect, in any one of the above-mentioned aspects, the plurality of surface images include a bright-field image that is picked up by using specularly reflected light from the illumination part as normal and a dark-field image that is picked up by using scattered light from the illumination part as normal.

In a still another preferred aspect, in any one of the above-mentioned aspects, the object to be inspected includes a main body part having a cylindrical or columnar shape. The illumination part includes: a dome configured to accommodate the object to be inspected; and a ring light having a ring shape, which is accommodated in the dome and is arranged so as to surround the object to be inspected. When a center axis of the image pickup part and the dome is referred to as a first center axis, a center axis of the main body part is referred to as a second center axis, and a center axis of the ring light is referred to as a third center axis, the holding part holds the object to be inspected under a state in which the second center axis is inclined at a predetermined first inclination angle with respect to the first center axis, the ring light is arranged so that the third center axis is inclined at a second inclination angle being different from the first inclination angle, and the bright-field image and the dark-field image are acquired through rotation of the ring light about the first center axis.

In still another preferred aspect, in any one of the above-mentioned aspects, the posture control part is configured to change the relative posture of the surface of the object to be inspected with respect to the image pickup part by displacing the holding part relative to the image pickup part being fixed.

In still another preferred aspect, in any one of the above-mentioned aspects, the object to be inspected is a piston for an internal combustion engine, and the surface of the object to be inspected is a crown surface of the piston.

Further, from another viewpoint, in one aspect, the inspection method is an inspection method for inspecting a surface of an object to be inspected, the inspection method including: an image pickup step of picking up a plurality of surface images while changing a relative posture of the surface of the object to be inspected with respect to the image pickup part configured to pick up an image of the surface of the object to be inspected under a state in which the surface of the object to be inspected is irradiated with light; and a discrimination step of discriminating between a defect and luminance unevenness of the surface of the object to be inspected based on a change in the plurality of surface images.

Further, from a further viewpoint, a method of manufacturing a piston includes: a first process of preparing a piston; a second process of inspecting a surface of the piston prepared in the first process, the second process including: an image pickup step of picking up a plurality of surface images while changing a relative posture of the piston with respect to the image pickup part configured to pick up an image of the surface of the piston under a state in which the surface of the piston is irradiated with light; and a discrimination step of discriminating between a defect and luminance unevenness of the surface of the piston based on a change in the plurality of surface images; and a third process of acquiring the piston inspected in the second process as a post-process.

Note that, the present invention is not limited to the above-mentioned embodiments, and includes various modification examples. For example, in the above-mentioned embodiments, the configurations are described in detail in order to clearly describe the present invention, but the present invention is not necessarily limited to an embodiment that includes all the configurations that have been described. Further, a part of the configuration of a given embodiment can replace the configuration of another embodiment, and the configuration of another embodiment can also be added to the configuration of a given embodiment. Further, another configuration can be added to, deleted from, and replace a part of the configuration of each of the embodiments.

The present application claims a priority based on Japanese Patent Application No. 2020-131675 filed on Aug. 3, 2020. All disclosed contents including Specification, Scope of Claims, Drawings, and Abstract of Japanese Patent Application No. 2020-131675 filed on Aug. 3, 2020 are incorporated herein by reference in their entirety.

### REFERENCE SIGNS LIST

1 inspection device
2 robot
3 camera (image pickup part)
4 illumination device (illumination part)
5 image processing apparatus
6 controller (posture control part)
7 main body part
7a crown surface
8 hand (holding part)
9 dome
10 ring light

1. An inspection device for inspecting a surface of an object to be inspected, the inspection device comprising:
a holding part configured to hold the object to be inspected;
an illumination part configured to irradiate a surface of the object to be inspected with light;
an image pickup part configured to pick up an image of the surface of the object to be inspected;
a posture control part configured to change a relative posture of the surface of the object to be inspected with respect to the image pickup part; and
a discrimination part configured to discriminate between a defect and luminance unevenness of the surface of the object to be inspected based on a change in a plurality of surface images that are picked up while the relative posture is being changed.

2. The inspection device according to claim 1,
wherein the change in the plurality of surface images is a change in luminance distribution, which corresponds to posture angles representing a plurality of the relative postures, and
wherein the discrimination part is configured to discriminate between the defect and the luminance unevenness of the surface of the object to be inspected based on the change in luminance distribution.

3. The inspection device according to claim 1, wherein the plurality of surface images include a bright-field image that is picked up by using specularly reflected light from the illumination part as normal and a dark-field image that is picked up by using scattered light from the illumination part as normal.

4. The inspection device according to claim 3,
wherein the object to be inspected includes a main body part having a cylindrical or columnar shape,
wherein the illumination part includes:
a dome configured to accommodate the object to be inspected; and
a ring light having a ring shape, which is accommodated in the dome and is arranged so as to surround the object to be inspected,
wherein, when a center axis of the image pickup part and the dome is referred to as a first center axis, a center axis of the main body part is referred to as a second center axis, and a center axis of the ring light is referred to as a third center axis,
the holding part holds the object to be inspected under a state in which the second center axis is inclined at a predetermined first inclination angle with respect to the first center axis,
the ring light is arranged so that the third center axis is inclined at a second inclination angle being different from the predetermined first inclination angle with respect to the first center axis, and
the bright-field image and the dark-field image are acquired through rotation of the ring light about the first center axis.

5. The inspection device according to claim 1, wherein the posture control part is configured to change the relative posture of the surface of the object to be inspected with respect to the image pickup part by displacing the holding part with respect to the image pickup part being fixed.

6. The inspection device according to claim 1, wherein the object to be inspected is a piston for an internal combustion engine, and the surface of the object to be inspected is a crown surface of the piston.

7. An inspection method for inspecting a surface of an object to be inspected, the method comprising:
an image pickup step of picking up a plurality of surface images while changing a relative posture of the surface of the object to be inspected with respect to an image pickup part configured to pick up an image of the surface of the object to be inspected under a state in which the surface of the object to be inspected is irradiated with light; and
a discrimination step of discriminating between a defect and luminance unevenness of the surface of the object to be inspected based on a change in the plurality of surface images.

8. A method of manufacturing a piston, comprising:
a first process of preparing a piston;
a second process of inspecting a surface of the piston prepared in the first process, the second process comprising:
an image pickup step of picking up a plurality of surface images while changing a relative posture of the surface of the piston with respect to an image pickup part configured to pick up an image of the surface of the piston under a state in which the surface of the piston is irradiated with light; and
a discrimination step of discriminating between a defect and luminance unevenness of the surface of the piston based on a change in the plurality of surface images; and
a third process of acquiring the piston inspected in the second process as a post-process.
